(19) United States
(12) Patent Application Publication
(10) Pub. No.: US 2002/0149155 A1
(43) Pub. Date: Oct. 17, 2002

(54) Cylinder head gasket

(76) Inventor: Karl Schmauder, Hulben (DE)

Correspondence Address: Mr. Edward J. Timer, Walnut Woods Center, 5955 W Main Street, Kalamazoo, MI, 49009, US

(21) Appl. No.: 09/832,546

(22) Filed: Apr. 11, 2001

(51) Int. Cl. F16J 15/02; F02F 11/00

(52) U.S. Cl. 277/591; 277/593

(57) ABSTRACT

The present invention relates to a cylinder head gasket comprising at least one metallic plate, whereby the cylinder head gasket comprises at least one combustion chamber passage opening and at least one further passage opening, and at least a first bead is formed on one of the metallic plates of the cylinder head gasket, said first bead being in the form of a closed continuous line which surrounds the combustion chamber passage opening, and at least a second bead is formed on one of the metallic plates of the cylinder head gasket, said second bead being in the form of a closed continuous line which surrounds the combustion chamber passage opening, wherein, from a top view of one of the main surfaces of the cylinder head gasket, the second bead surrounds the first bead and the further passage opening is disposed in the region between the first bead and the second bead, wherein the first bead is provided with a first coating containing an elastomeric component and the second bead is provided with a second coating containing an elastomeric component and wherein the second coating has a greater average layer thickness than the first coating at least in a sub-section of the second bead.

The present invention relates to a cylinder head gasket comprising at least one metallic plate, whereby the cylinder head gasket comprises at least one combustion chamber passage opening and at least one further passage opening, and at least a first bead is formed on one of the metallic plates of the cylinder head gasket, said first bead being in the form of a closed continuous line which surrounds the combustion chamber passage opening, and at least a second bead is formed on one of the metallic plates of the cylinder head gasket, said second bead being in the form of a closed continuous line which surrounds the combustion chamber passage opening, whereby, from a top view of one of the main surfaces of the cylinder head gasket, the second bead surrounds the first bead and the further passage opening is disposed in the region between the first bead and the second bead, and whereby the first bead is provided with a first coating containing an elastomeric component and the second bead is provided with a second coating containing an elastomeric component.

Such a cylinder head gasket is known from the U.S. Pat. No. 5,582,415 (Yoshida et al.) for example.

In the cylinder head gasket known from the U.S. Pat. No. 5,582,415, passage openings for a cooling medium are disposed in the region between the first bead and the second bead which is at least partially uncoated for preventing the cooling medium coming into contact with the coatings on the first bead and the second bead.

Furthermore, the U.S. Pat. No. 5,582,415 discloses that the coating on the first bead surrounding the combustion chamber passage opening should be thicker than the other coatings on the cylinder head gaskets so as to produce an especially gas-tight seal in the region of the combustion chamber passage opening.

However, in conjunction with the high surface pressure prevailing there, the large layer thickness of the coating on the first bead arranged in the immediate vicinity of the combustion chamber passage opening leads to a considerable quantity of the material in this coating shearing off and thereby flowing into the combustion chamber passage opening and thus leading to reduced continuous creep strength.

In addition, having a very low layer thickness for the coating on the second bead arranged more distantly from the combustion chamber passage opening results in it not being possible for this coating to ensure an adequate degree of micro-sealing of the rough surfaces of the components being sealed (the engine block or the cylinder head) in the vicinity of the second bead due to the very low surface pressure existing there in comparison with the surface pressure prevailing at the combustion chamber passage opening.

Consequently, the object of the present invention is to provide a cylinder head gasket of the type described hereinabove which comprises a high continuous creep strength whilst simultaneously ensuring an adequate degree of micro-sealing at each of the jointing lines of the cylinder head gasket.

In accordance with the invention, this object is achieved by a cylinder head gasket according to claim 1 wherein the second coating disposed on the second bead has a greater average layer thickness than the first coating on the first bead at least in a sub-section of the second bead.

This concept is exactly the opposite of the teaching provided by the U.S. Pat. No. 5,582,415 since, in accordance with the U.S. Pat. No. 5,582,415, the coatings on each of the other beads should have a lower layer thickness than that of the coating on the first bead which is arranged in the immediate vicinity of the combustion chamber passage opening.

Due to the concept in accordance with the invention and by virtue of the greater average layer thickness of the second coating, it is ensured that there will also be an adequate degree of micro-sealing of the second bead which is arranged more distantly from the combustion chamber passage opening and which is subjected to a lower surface pressure.

At the same time, due to the comparatively lower average layer thickness of the first coating on the first bead which is arranged in the immediate vicinity of the combustion chamber passage opening and is thus subjected to a high surface pressure, it is ensured that the material of the first coating will not flow into the combustion chamber passage opening.

The average layer thickness of the second coating preferably amounts to at least approximately 1.5, and, in particular, to at least approximately 1.8 times the average layer thickness of the first coating.

If the cylinder head gasket comprises a plurality of metallic plates, then basically, provision may be made for the first bead and the second bead to be formed on different metallic plates of the cylinder head gasket.

However, provision is preferably made for the first bead and the second bead to be formed on the same metallic plate of the cylinder head gasket. In this way, an intermediate space that is sealed by the two beads is formed between the first bead and the second bead, whereby this intermediate space can be filled by a fluid, a cooling medium for example, which flows through the cylinder head gasket when the gasket is in use.

Basically, the first coating and the second coating could be disposed on different sides of the metallic plate.

However, provision is preferably made for the first coating and the second coating to be formed on the same side of the same metallic plate. It is thereby possible to deposit the first coating and the second coating in one and the same operational process.

In a preferred embodiment of the cylinder head gasket, there is provided between the first coating and the second coating, a region of the metallic plate which does not comprise a coating containing an elastomeric component. The quantity of coating material needed can be reduced by virtue of such a partial coating of the metallic plate.

The first bead is preferably formed on an outer cover plate of the cylinder head gasket i.e. on a metallic plate that is in contact with the engine block or the cylinder head. The second bead is also preferably formed on an outer cover plate of the cylinder head gasket.

Basically, the first bead and the second bead could have any arbitrary bead cross-section.

However, provision is preferably made for the first bead to be in the form of an entire bead whilst the second bead is preferably in the form of a semi-bead.

The first coating is preferably formed on an outer face of the cylinder head gasket so that the first coating will be in direct contact with the component requiring sealing i.e. it will be in direct contact with the engine block or the cylinder head.

The second coating is also preferably formed on an outer face of the cylinder head gasket.

In order to prevent material from the first coating entering the combustion chamber passage opening, it is advantageous if there is provided between the first coating and the combustion chamber passage opening, a region of the metallic plate which does not comprise a coating containing an elastomeric component.

In order to achieve adequate continuous creep strength, the first coating preferably has an average layer thickness of approximately 10 μm to approximately 40 μm.

It is particularly expedient if the first coating has an average layer thickness of approximately 13 μm to approximately 33 μm.

In order to ensure an adequate degree of micro-sealing in the vicinity of the second bead, the second coating preferably has an average layer thickness of approximately 20 μm to approximately 60 μm.

It is particularly expedient if the second coating has an average layer thickness of approximately 30 μm to approximately 50 μm.

Furthermore, provision may be made for the metallic plate provided with the first coating and/or the metallic plate provided with the second coating to be additionally provided with a non-stick coating.

A particularly high degree of freedom in regard to the shape of the first coating and the second coating will be obtained if the first coating and/or the second coating is deposited on the metallic plate by means of a screen printing process.

A suitable screen printing process is described in the U.S. Pat. No. Specification 4,761,364, the content of which is deemed to be included in this description by virtue of the reference thereto (“incorporation by reference”).

In a preferred embodiment of the cylinder head gasket, provision is made for the second bead to extend at least partially along a periphery of the metallic plate. The surface pressures that are effective on the second bead along this periphery are very small so that the large average layer thickness of the second coating is effective in a particularly expedient manner. Moreover, due to the fact that the second bead extends along the periphery of the metallic plate, there is an extensive region available between the first bead and the second bead for the disposition of fluid passage openings, for example, passage openings for a cooling medium.

The further passage opening, which is disposed in the region between the first bead and the second bead, is preferably a fluid passage opening, and especially a passage opening for a cooling medium.

It is particularly expedient in this case if the further passage opening is disposed in a region of the cylinder head gasket which does not comprise a coating containing an elastomeric component. The effect is thereby achieved that the danger, that parts of the elastomeric coatings will be dissolved by the fluid and especially by the cooling medium when the cylinder head gasket is in use and might therefore be carried along in the circulating system for the cooling medium, is minimised.

In a preferred embodiment of the cylinder head gasket in accordance with the invention, provision is made for the second coating in each sub-section of the second bead to have a higher average layer thickness than that of the first coating.

Furthermore, provision may be made for a bead, which at least partially surrounds a passage opening in the cylinder head gasket for an attachment means, to be formed on one of the metallic plates of the cylinder head gasket, whereby this bead is provided with a third coating containing an elastomeric component and whereby the third coating has a lower average layer thickness than that of the second coating.

Namely, having a large layer thickness for the coating of a bead which is adjacent to the passage opening in the cylinder head gasket for an attachment means, could lead to a gradual reduction in the force which was originally applied to the cylinder head gasket (this force being referred to as the bolting force) and with which the components requiring sealing (the engine block and the cylinder head) are restrained against each other by means of the attachment elements (especially the cylinder head bolts). During the process of installing the gasket, a specific initial bolting force is set by tightening up the cylinder head bolts, whereby said force corresponds to a specific degree of compression of the beads surrounding the passage openings for the bolts. Should the material of the coating be partially displaced from the sealing bead lines when the cylinder head gasket is in use, then the degree of compression of the beads will reduce, and so too, will the bolting force effective on the seal.

Due to the fact that the coating provided on the beads surrounding the passage openings for the attachment means has a smaller average layer thickness than that of the second coating, such a loss of bolting force will be prevented or at least minimised.

The average layer thickness of the third coating is preferably substantially the same as that of the first coating i.e. the coating on the first bead which is adjacent to the combustion chamber passage opening.

Furthermore, the present invention relates to a cylinder head gasket comprising at least one metallic plate, whereby the cylinder head gasket comprises at least one passage opening for an attachment means and at least one further passage opening, and a first beaded region is formed on one of the metallic plates of the cylinder head gasket, said first beaded region being adjacent to the passage opening for an attachment means, and a second beaded region is formed on one of the metallic plates of the cylinder head gasket, said second beaded region being adjacent to the further passage opening, wherein the first and the second beaded regions are each provided with a respective coating containing an elastomeric component and wherein the coating on the first beaded region has a lower average layer thickness than the coating on the second beaded region.

The provision of a comparatively thin coating on the beaded region adjacent the passage opening for the attachment means provides the previously explained advantage of preventing or at least reducing the decrease in the bolting force effective on the gasket.

This concept is exactly the opposite of the teaching provided by the U.S. Pat. No. 5,582,415 since, in accordance with the U.S. Pat. No. 5,582,415, the thickness of the coating should reduce as the distance from the passage opening for the attachment means increases.

Further features and advantages of the invention form the subject matter of the following description and the sketched illustration of an embodiment.

In the drawings,

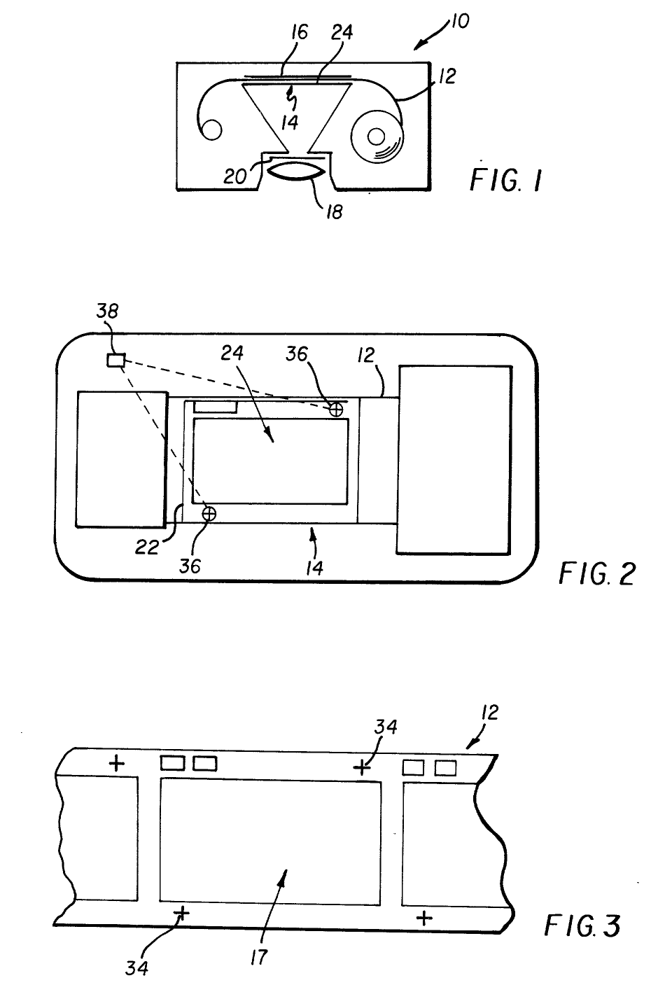

FIG. 1 shows a top view of a main surface of a three layer cylinder head gasket;

FIG. 2a section through the cylinder head gasket of FIG. 1 along the line 2-2 in FIG. 1;

FIG. 3a section through the cylinder head gasket of FIG. 1 along the line 3-3 in FIG. 1;

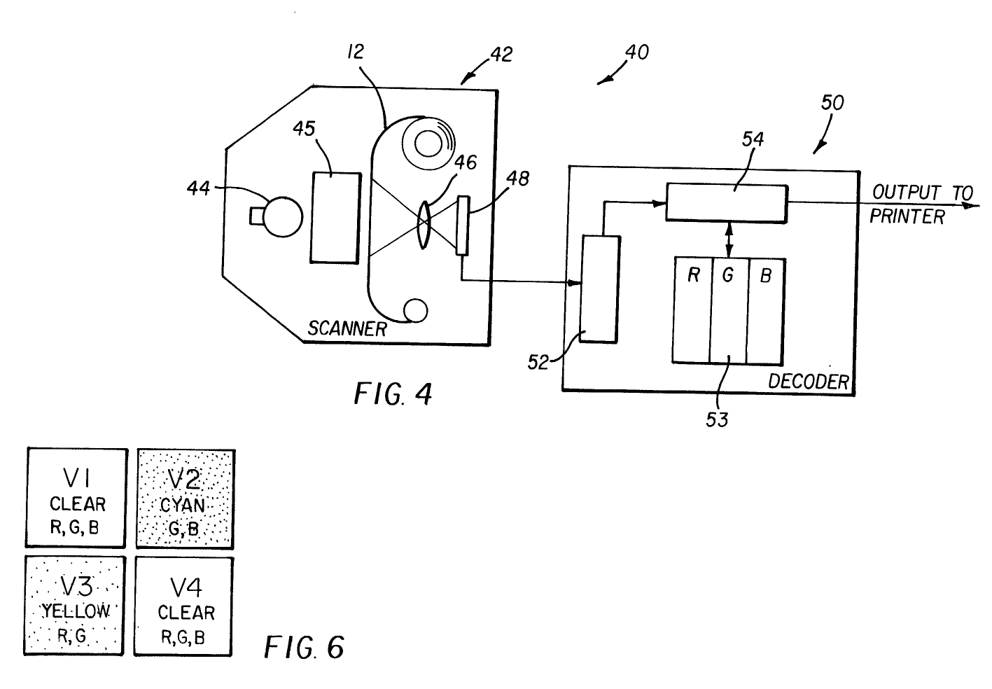

FIG. 4a section through the cylinder head gasket of FIG. 1 along the line 4-4 in FIG. 1; and

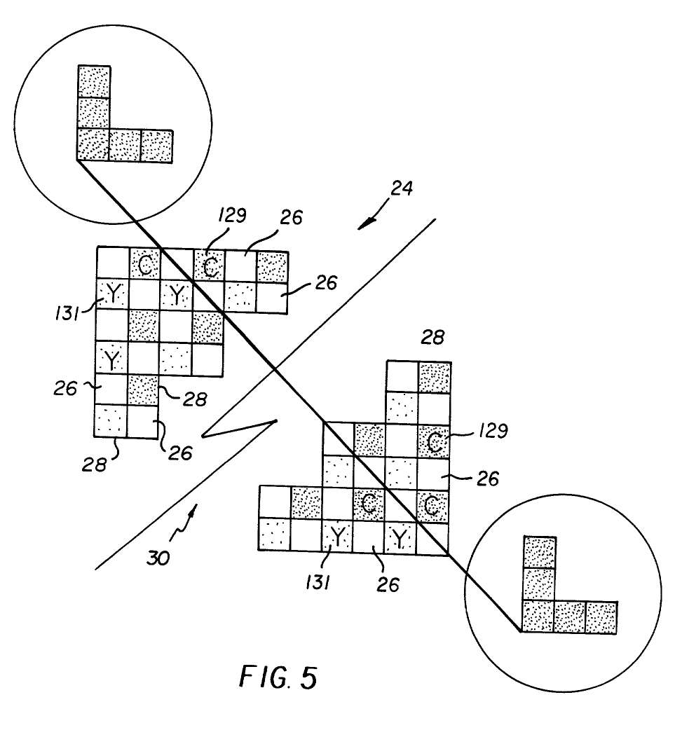

FIG. 5a section corresponding to FIG. 4 through a second embodiment of a cylinder head gasket.

Similar or functionally equivalent elements are provided with the same reference symbols in each of the Figures.

A three layer cylinder head gasket bearing the general reference 100 that is illustrated in FIGS. 1 to 4 and is intended to be disposed between the engine block and the cylinder head of an internal combustion engine comprises a metallic upper cover plate 102, a metallic lower cover plate 104 and an intermediate metallic plate 106 arranged between the cover plates 102 and 104 (see FIGS. 2 to 4).

The upper cover plate 102 and the lower cover plate 104 are made of a spring steel, for example from the steel having the reference AISA-301/SAE-30301, and they each have a thickness of approximately 0.20 millimeters.

The intermediate plate 106 is manufactured from the steel having the reference AISA/SAE-A620 (1008) for example, and it has a thickness of approximately 0.12 millimeters.

Substantially mutually aligned through holes are formed in each of the three plates 102, 104 and 106 by a punching process for example, whereby, together, they form the following passage openings which extend through the cylinder head gasket 100 at right angles to the main surfaces thereof:

a plurality, four for example, of circular combustion chamber passage openings 108;

a plurality, two for example, of passage openings 110 for a positioning means, whereby these said passage openings serve for positioning the cylinder head gasket 100 relative to the engine block or the cylinder head by means of an appropriate positioning means, for example, by means of positioning pins or dowel screws;

a plurality of passage openings 112 for attachment means, whereby these said passage openings serve for accommodating attachment means, bolts for example, by means of which the engine components that are to be sealed with the aid of the cylinder head gasket 100 are drawn tightly together;

a plurality of passage openings 114 for a cooling medium, whereby these said passage openings serve for the passage of a cooling medium through the cylinder head gasket 100, for example, water; and

a plurality of tappet passage openings 116, whereby these said passage openings serve for the passage of the valve tappets through the cylinder head gasket 100.

As can be appreciated from FIGS. 1 to 3, both the upper cover plate 102 and the lower cover plate 104 are provided with first beads 118 each of which concentrically surrounds a combustion chamber passage opening 108.

Each of the first beads 118 is in the form of an entire bead having a central bead crest 120 as well as an inner bead foot 122 and an outer bead foot 124 which form the lateral borders of the first beads 118.

Each of the first beads 118 is constructed in such a manner that the concave side thereof points towards the outside of the cylinder head gasket and the bead crest 120 thereof rests on the intermediate plate 106.

As can be appreciated from FIGS. 2 and 3, the outer face of each of the first beads 118 remote from the intermediate plate 106 is provided with a first coating 126 which forms coating strips that completely cover the first beads 118. In particular, the first coating covers the inner bead foot 122 and the outer bead foot 124 as well as the region of each first bead 118 located between the bead feet 122, 124.

The first coating 126 extends up to an inner edge 128 in the direction towards each of the combustion chamber passage openings 108. An annular uncoated region 130 having a width of approximately 0.5 millimeters remains between the inner edge 128 and the rim of the combustion chamber passage opening 108. The first coating 126 extends up to an outer edge 134 on the side of each of the first beads 118 remote from the combustion chamber passage opening 108 (see FIG. 2).

The region of the narrow areas between two mutually adjacent combustion chamber passage openings 108 is completely covered by the first coating 126 (see FIG. 3).

The edges of the first coating 126 are indicated by dashed double dotted lines (-..-..) in FIG. 1.

The first coating 126 incorporates at least one elastomeric component and thus has resilient properties.

A fluorelastomer (corresponding to ASTM-D 1418-85) having the following composition may, for example, be used as the material for the first coating 126:

100 parts fluorelastomer;

30 parts carbon black;

70 parts of other fillers;

1.5 parts of a vulcanising agent;

0.5 parts of a defoaming agent;

300 parts of a suitable solvent.

The average layer thickness of the first coating 126 amounts to approximately 10 μm to approximately 40 μm, and preferably approximately 13 μm to approximately 33 μm. An average layer thickness of approximately 20 μm is particularly appropriate.

The first coating 126 is applied by means of a screen printing process for example after the upper cover plate 102 and the lower cover plate 104 have been provided with the first beads 118.

A suitable screen printing process is described in the U.S. Pat. No. 4,763,364 for example, the content of which is deemed to be included in this description by virtue of the reference thereto (“incorporation by reference”).

Furthermore, the upper cover plate 102 and the lower cover plate are each provided with a respective second bead 134 which forms a closed continuous line train that surrounds the combustion chamber passage openings 108 and also the first beads 118, as well as the passage openings 114 for the cooling medium, five for example, and the passage openings 112 for the attachment means which are provided with the reference 112a hereinafter.

The contour of the second bead 134 is akin to a rectangle whereby the second bead 134 extends along a long side 136 of the rectangle and along two narrow sides 138 of the rectangle near the peripheries of the respective cover plates 102 and 104, whilst the second bead 134 extends along the other long side 140 of the rectangle between the combustion chamber passage openings 108 on the one hand and the passage openings 116 for the tappets as well as a plurality, three for example, of further passage openings 112 for the attachment means, which will be referenced by 112b hereinafter, on the other.

The second bead 134 is in the form of a semi-bead having an outer bead edge 142 which faces the periphery of the respective cover plate 102, 104 and rests on the intermediate plate 106, and a bead edge 144 which faces the combustion chamber passage openings 108 (see FIGS. 2 and 4).

Each of the second beads 134 is provided with a second coating 146 on the outer face of the relevant cover plate 102, 104, which coating forms a strip that completely covers the respective second bead 134, and especially the outer bead edge 142 and the inner bead edge 144, said strip ending within the inner bead edge 144 at an inner edge 148 of the second coating 146 and outside the outer bead edge 142 at an outer edge 150 of the second coating 146.

The edges of the second coating 146 are indicated by broken lines (- -) in FIG. 1.

The second coating 146 comprises at least one elastomeric component and thus has resilient properties.

An elastomer material based upon nitrile butadine rubber (NBR) is especially suitable as the material for the second coating 146. A suitable composition could, for example, comprise:

100 parts NBR polymmer;

50 parts carbon black;

150 parts of other fillers;

5 parts of a vulcanising agent;

15 parts of a suitable resin;

900 parts of a suitable solvent.

However, the same material containing an elastomeric component could be used for the second coating 146 as was used for the first coating 126. The use of the same material for both coatings has the advantage that both coatings can be deposited in one and the same operational process.

The average layer thickness of the second coating 146 amounts to approximately 20 μm to approximately 60 μm, and preferably approximately 30 μm to approximately 50 μm. An average layer thickness of approximately 40 μm has proved to be particularly appropriate for the second coating 146.

The average layer thickness of the second coating 146 is greater than the average layer thickness of the first coating 126 in every case.

The first coating 126 and the second coating 146 are not drawn to scale in FIGS. 2 to 4 but rather, they are greatly exaggerated for the sake of clarity.

The second coating 146 may also be deposited by means of a screen printing process such as is described in the U.S. Pat. No. 4,763,364 for example, the content of which is deemed to be included in this description by virtue of the reference thereto (“incorporation by reference”).

Furthermore, the upper cover plate 102 and the lower cover plate are provided with third beads 152 which concentrically surround a respective one of the passage openings 112a for the attachment means, said passage openings being disposed in the region between the first beads 118 and the second bead 134.

As is apparent from FIG. 4, these beads 152 are also in the form of semi-beads which have an inner bead edge 154 that faces the respective passage opening 112a for the attachment means and rests on the intermediate plate 106, and an outer bead edge 156 that is remote from the respective passage opening 112a for the attachment means.

As is apparent from FIG. 4, the second coating 146 not only covers the second bead 134 but also the third beads 152 on the relevant cover plates 102, 104 and it ends at an inner edge 158 which is spaced from the rim of the respective passage opening 112a for the attachment means.

Furthermore, the upper cover plate 102 and the lower cover plate 104 are each provided with a fourth bead 160 which extends outside the respective second bead 134 and surrounds the tappet passage openings 116 as well as a major portion of the passage openings for the attachment means that are disposed outside the second bead 134 (see FIG. 1).

This fourth bead 160 is also in the form of a semi-bead having an inner bead edge 162 that faces the tappet passage openings 116 and an outer bead edge 164 that is remote from the tappet passage openings 116 and rests on the intermediate plate 106.

Some of the passage openings for the attachment means that are disposed within the fourth bead 160 and are referenced 112c hereinafter, and the passage openings for the attachment means 112d that are disposed outside the second bead 134 are each surrounded concentrically by fifth beads 166 (see FIG. 1).

These fifth beads 166 are also in the form of semi-beads having an inner bead edge 168 that faces the respective passage opening 112d for the attachment means and an outer bead edge 170 that is remote from the respective passage opening 112d for the attachment means and rests on the intermediate plate 106.

The fourth beads 160 and the fifth beads 166 are also completely covered by the second coating 146.

As is best apparent from the top view of FIG. 1, an uncoated region 172 remains between the inner edge 148 of the second coating 146 and the outer edge 132 of the first coating 126, said region being free of the first coating 126 and also free of the second coating 146 and being surrounded on the one hand by the first beads 118 having the first coating 126, and by the second bead 134 having the second coating 146 on the other.

The passage openings 114 through the cylinder gasket 100 for the cooling medium are disposed in this uncoated region 172.

By virtue of this arrangement of the passage openings 114 for the cooling medium in the uncoated region 172, the effect is thereby achieved that the danger, that parts of the elastomeric coatings will be dissolved by the cooling medium and might therefore be carried along in the circulating system for the cooling medium when the cylinder head gasket 100 is in use, is minimised.

The first coating 126 and the second coating 146 for each cover plate 102, 104 may be deposited onto the respective cover plate in one and the same operational process or in different operational processes.

Furthermore, it is also conceivable for the first coating 126 and a lower portion of the second coating 146, which has substantially the same average layer thickness as that of the first coating 126, to be deposited together in a first operational process. An upper portion of the second coating 146 can then be deposited in a second operational process so as to provide the second coating 146 with an overall average layer thickness that is larger than that of the first coating 126.

In the embodiment outlined above, provision is made for the second coating 146 to extend not just over the second bead 134, but also over the third beads 152, the fourth beads 160 and the fifth beads 166.

However, it would also be possible to provide the third beads 152, the fourth beads 160 and the fifth beads 166 with respective special coatings which may be distinguished from the second coating 146 on the second bead 134 in regard to the composition of the coating material used therefor and/or in regard to the average layer thickness thereof.

Furthermore, provision may be made for the upper cover plate 102 and/or the lower cover plate 104 to be provided with a non-stick coating on the outer faces thereof, which coating covers the first coating 126 and the second coating 146 and the uncoated regions of these plates.

The non-stick coating may be formed from a conventional polyethylene wax material for example, and it preferably has an average layer thickness of approximately 1 μm to approximately 5 μm.

The non-stick coating does not contain any elastomeric components and consequently does not have resilient properties.

The intermediate plate 106 is provided with folded borders 174 along the rim of the combustion chamber passage openings 108, said borders serving as stoppers for the first beads 118 and limiting the deformation path thereof (see FIGS. 2 and 3).

Furthermore, the intermediate plate 106 may be provided, preferably on each side thereof, with a (not illustrated) coating covering the entire surface thereof, which coating contains an elastomeric component and has an average layer thickness of approximately 8 μm to approximately 14 μm for example.

A second embodiment of a cylinder head gasket 100 illustrated in FIG. 5 differs from the first embodiment described hereinabove in that the third beads 152, which concentrically surround a respective one of the passage openings 112a for the attachment means that are disposed in the region between the first beads 118 and the second bead 134, are not provided with the second coating 146, but instead, with a third coating 176, whereby the third coating 176 has an average layer thickness which is less than the average layer thickness of the second coating 146.

The third coating 176 is illustrated by the dash-dotted lines (-.-.) in FIG. 5.

The average layer thickness of the third coating 176 amounts to approximately 10 μm to approximately 40 μm, and preferably to approximately 13 μm to approximately 33 μm. An average layer thickness of approximately 20 μm is particularly suitable.

The average layer thickness of the third coating 176 is preferably substantially the same as the average layer thickness of the first coating 126.

The same material as was used for the first coating 126 may also be used for the third coating 176, and the third coating 176 may be deposited in the one and the same operational process as the first coating 126, for example, by means of a screen printing process.

Due to the reduced layer thickness of the third coating 176 located adjacent to the passage openings 112a for the attachment means relative to that of the second coating 146, a gradual reduction in the pressing force exerted on the cylinder head gasket 100 by the attachment means, which reduction might otherwise occur by virtue of a partial displacement of the coating from the third beads 152 when the gasket is in use, will be prevented or at least minimised.

Apart from the third beads 152, the fifth beads 166, which surround the passage openings 112c for the attachment means and the passage openings 112d for the attachment means, may be provided with the third coating 176 rather than the second coating 146.

Furthermore, in order to prevent a reduction in the pressing force effective on the cylinder head gasket 100, provision may also be made for the sections of the second beads 134 that are adjacent the passage openings 112b for the attachment means and/or the fourth bead 160 to have a reduced average layer thickness which preferably substantially corresponds to the average layer thickness of the third coating 176.

1. A cylinder head gasket comprising at least one metallic plate, whereby the cylinder head gasket comprises at least one combustion chamber passage opening and at least one further passage opening and
at least a first bead is formed on one of the metallic plates of the cylinder head gasket, said first bead being in the form of a closed continuous line which surrounds the combustion chamber passage opening and
at least a second bead is formed on one of the metallic plates of the cylinder head gasket, said second bead being in the form of a closed continuous line which surrounds the combustion chamber passage opening,
wherein, from a top view of one of the major surfaces of the cylinder head gasket, the second bead surrounds the first bead and the further passage opening is disposed in the region between the first bead and the second bead,
wherein the first bead is provided with a first coating containing an elastomeric component, and the second bead is provided with a second coating containing an elastomeric component and
wherein the second coating has a greater average layer thickness than that of the first coating at least in a sub-section of the second bead.

2. A cylinder head gasket in accordance with claim 1, wherein the first bead and the second bead are formed on the same metallic plate of the cylinder head gasket.

3. A cylinder head gasket in accordance with claim 2, wherein the first coating and the second coating are formed on the same side of the same metallic plate.

4. A cylinder head gasket in accordance with claim 3, wherein there is provided between the first coating and the second coating, a region of the metallic plate which does not comprise a coating containing an elastomeric component.

5. A cylinder head gasket in accordance with claim 1, wherein the first bead is formed on an outer cover plate of the cylinder head gasket.

6. A cylinder head gasket in accordance with claim 1, wherein the second bead is formed on an outer cover plate of the cylinder head gasket.

7. A cylinder head gasket in accordance with claim 1, wherein the first bead is in the form of an entire bead.

8. A cylinder head gasket in accordance with claim 1, wherein the second bead is in the form of a semi-bead.

9. A cylinder head gasket in accordance with claim 1, wherein the first coating is formed on an outer face of the cylinder head gasket.

10. A cylinder head gasket in accordance with claim 1, wherein the second coating is formed on an outer face of the cylinder head gasket.

11. A cylinder head gasket in accordance with claim 1, wherein there is provided between the first coating and the combustion chamber passage opening, a region of the metallic plate which does not comprise a coating containing an elastomeric component.

12. A cylinder head gasket in accordance with claim 1, wherein the first coating has an average layer thickness of approximately 10 μm to approximately 40 μm.

13. A cylinder head gasket in accordance with claim 1, wherein the first coating has an average layer thickness of approximately 13 μm to approximately 33 82 m.

14. A cylinder head gasket in accordance with claim 1, wherein the second coating has an average layer thickness of approximately 20 μm to approximately 60 μm.

15. A cylinder head gasket in accordance with claim 14, wherein the second coating has an average layer thickness of approximately 30 μm to approximately 50 μm.

16. A cylinder head gasket in accordance with claim 1, wherein the metallic plate provided with the first coating and/or the metallic plate provided with the second coating is additionally provided with a non-stick coating.

17. A cylinder head gasket in accordance with claim 1, wherein the first coating and/or the second coating is deposited on the metallic plate by means of a screen printing process.

18. A cylinder head gasket in accordance with claim 1, wherein the second bead extends at least partially along a periphery of the metallic plate.

19. A cylinder head gasket in accordance with claim 1, wherein the further passage opening, which is disposed in the region between the first bead and the second bead, is a fluid passage opening, preferably a passage opening for a cooling medium.

20. A cylinder head gasket in accordance with claim 19, wherein the further passage opening is disposed in a region of the cylinder head gasket which does not comprise a coating containing an elastomeric component.

21. A cylinder head gasket in accordance with claim 1, wherein the second coating in each sub-section of the second bead has a higher average layer thickness than that of the first coating.

22. A cylinder head gasket in accordance with claim 1, wherein a bead, which at least partially surrounds a passage opening for an attachment means, is formed on one of the metallic plates of the cylinder head gasket, wherein this said bead is provided with a third coating containing an elastomeric component and wherein the third coating has a lower average layer thickness than that of the second coating.

23. A cylinder head gasket in accordance with claim 22, wherein the average layer thickness of the third coating is substantially the same as that of the first coating.

24. A cylinder head gasket comprising at least one metallic plate, whereby the cylinder head gasket comprises at least one passage opening for an attachment means and at least one further passage opening and
a first beaded region is formed on one of the metallic plates of the cylinder head gasket, said first beaded region being adjacent to the passage opening for the attachment means and
a second beaded region is formed on one of the metallic plates of the cylinder head gasket, said second beaded region being adjacent to the further passage opening,
wherein the first and the second beaded regions are each provided with a respective coating containing an elastomeric component and
wherein the coating of the first beaded region has a lower average layer thickness than the coating of the second beaded region.
